(19) United States
(12) Patent Application Publication
(10) Pub. No.: US 2026/0280114 A1
(43) Pub. Date: Sep. 17, 2026

(54) ELECTRONIC DEVICE

(71) Applicant: Sony Interactive Entertainment Inc., Tokyo (JP)

(72) Inventors: Sho Kobayashi, Tokyo (JP); Kazuya Odagiri, Tokyo (JP); Yutaka Sumi, Tokyo (JP); Naoki Miwatani, Tokyo (JP); Kota Hatano, Tokyo (JP); Yuta Tamaki, Tokyo (JP); Kazu Suzuki, Tokyo (JP)

(21) Appl. No.: 19/156,947

(22) PCT Filed: Feb. 7, 2024
(86) PCT No.: PCT/JP2024/004152

§ 371 Date: Aug. 15, 2025

(30) Foreign Application Priority Data
Feb. 20, 2023 (JP) 2023-024588

(51) Int. Cl. H01Q 1/52; H01Q 1/22; H01Q 1/48

(52) U.S. Cl. CPC H01Q 1/52; H01Q 1/22; H01Q 1/48

(57) ABSTRACT

Provided is an electronic device including an antenna for performing wireless communication, a noise source that causes generation of radiation current, and a conductive member that is disposed on a propagation path of the radiation current from the noise source to the antenna and has a projecting portion projecting from the propagation path. An electrical length to a tip end of the projecting portion is equal to or larger than one-eighth but equal to or smaller than three-eighths of a wavelength used in the wireless communication.

### TECHNICAL FIELD

The present invention relates to an electronic device having an antenna for wireless communication.

### BACKGROUND ART

There is known an electronic device capable of performing wireless communication connection with another communication device, for example, wireless local area network (LAN) communication based on the IEEE802.11 standard or wireless communication based on the Bluetooth (registered trademark) standard. Such an electronic device has an antenna for performing wireless communication.

### SUMMARY

### Technical Problem

Among electronic parts mounted on an electronic device, there is a potential noise source that generates radiation current, for example, a communication connector for transmitting and receiving signals externally with a relatively high-speed clock. The radiation current generated from such a noise source is propagated through a ground of a circuit in the electronic device and may adversely affect wireless communication using an antenna.

The present invention has been made in view of the circumstances described above, and it is one of objects of the present invention to provide an electronic device capable of suppressing propagation of radiation current from a noise source to an antenna.

### Solution to Problem

According to the present invention, there is provided an electronic device including an antenna for performing wireless communication, a noise source that causes generation of radiation current, and a conductive member that is disposed on a propagation path of the radiation current from the noise source to the antenna and has a projecting portion projecting from the propagation path. An electrical length to a tip end of the projecting portion is equal to or larger than one-eighth but equal to or smaller than three-eighths of a wavelength used in the wireless communication.

### BRIEF DESCRIPTION OF DRAWINGS

FIG. 1 is a diagram illustrating a board incorporated in an electronic device according to a first embodiment of the present invention.

FIG. 2 is a diagram illustrating a conductive member provided in the electronic device according to the first embodiment of the present invention, as viewed in a horizontal direction.

FIG. 3 is a diagram illustrating an example of distribution of radiation current in a case where the conductive member is not provided.

FIG. 4 is a diagram illustrating an example of the distribution of the radiation current in a case where the conductive member is provided.

FIG. 5 is a diagram illustrating a plurality of boards incorporated in an electronic device according to a second embodiment of the present invention.

FIG. 6 is a diagram illustrating a board incorporated in an electronic device according to a modification example of the present invention.

FIG. 7 is a diagram illustrating a conductive member provided in an electronic device according to another modification example of the present invention, as viewed in the horizontal direction.

FIG. 8 is a diagram illustrating a conductive member provided in an electronic device according to another modification example of the present invention, as viewed in the horizontal direction.

FIG. 9 is a diagram illustrating a conductive member provided in an electronic device according to another modification example of the present invention, as viewed in the horizontal direction.

### DESCRIPTION OF EMBODIMENTS

Embodiments of the present invention are hereinafter described in detail with reference to the drawings.

### First Embodiment

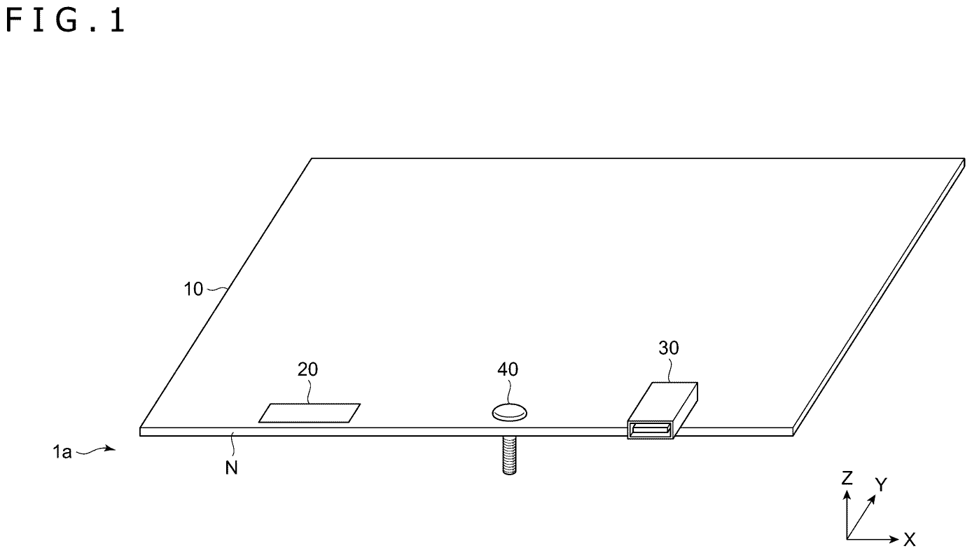

An electronic device 1a according to a first embodiment of the present invention is, for example, a personal computer, a stationary game device, a portable game device, a smartphone, or the like and includes a board 10, an antenna 20 for wireless communication connection with another electronic device, and a connector 30 for wired communication connection with another electronic device. FIG. 1 illustrates an exemplary appearance of the board 10 incorporated in the electronic device 1a.

The board 10 is an electronic circuit board on which various circuit elements for implementing functions of the electronic device 1a are mounted. In the present embodiment, the board 10 is a flat plate shaped in a rectangle in plan view as illustrated in FIG. 1. In the following, for convenience of explanation, a lateral direction and a longitudinal direction of the board 10 are represented by an X axis and a Y axis, respectively, and the board 10 is assumed to be disposed to lie in parallel with an XY plane. Further, a direction orthogonal to the board 10 is represented by a Z axis, with a direction toward a front surface side of the board 10 being referred to as a Z-axis positive direction and a direction toward a back surface side of the board 10 being referred to as a Z-axis negative direction.

The antenna 20 is a circuit element used for the electronic device 1a to perform wireless communication with another communication device. In the present embodiment, the antenna 20 is a pattern antenna formed on the board 10. Further, the antenna 20 is disposed near one side among four sides constituting an outer boundary of the board 10. The one side near which the antenna 20 is disposed among the sides constituting the outer boundary of the board 10 is referred to as a side N below. In this example, the side N is a side extending along the X-axis direction.

The connector 30 is a circuit element for the electronic device 1a to establish wired communication connection with another communication device and may be, for example, a universal serial bus (USB) receptacle used in communication with another USB device based on the USB3.0 standard. Alternatively, the connector 30 may be a high-definition multimedia interface (HDMI; registered trademark) connector for transmission and reception of video signals based on the HDMI standard. In the present embodiment, the connector 30 is fixed along the side N and oriented outward (Y-axis negative direction side).

When another communication device is connected via a cable or the like to the connector 30 and communication is established between the electronic device 1a and the connected communication device, radiation current is as a result generated on a ground pattern formed on the front surface of the board 10. This radiation current is propagated through a ground of the board 10 on which the connector 30 is mounted, which may lead to an adverse influence on other circuit elements. In this respect, the connector 30 acts as a noise source.

The radiation current generated from the connector 30 is mainly propagated on the board 10 along the outer boundary of the board 10. In the present embodiment, since the antenna 20 and the connector 30 are both disposed along the side N of the board 10, unless any countermeasure is taken, there is a high possibility that the radiation current generated from the connector 30 and propagated along the side N of the board 10 interferes with the wireless communication of the antenna 20. In order to suppress such radiation current, a screw 40 is fixed at a position near the side N of the board 10.

The screw 40 is a conductive member formed from a conductive material such as iron and is disposed at a position near the side N of the board 10 between the antenna 20 and the connector 30. Further, the screw 40 has a head 41 positioned on the front surface side of the board 10 and a body portion 42 disposed in such a manner as to extend through a through hole 11 defined in the board 10 and be oriented to the Z-axis negative direction.

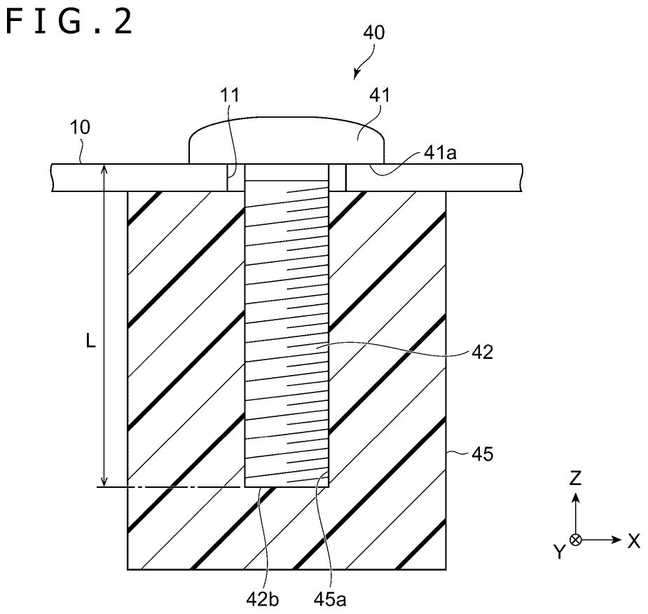

FIG. 2 is a diagram schematically illustrating the screw 40 fixed to the board 10, as viewed in a horizontal direction. The radiation current generated from the connector 30 is propagated along the ground pattern formed on the front surface of the board 10. Since a bottom surface 41a of the head 41 of the screw 40 makes contact with this ground pattern, the screw 40 is electrically connected to a propagation path of the radiation current. Thus, the radiation current flows through a path taking a bypass along a surface of the body portion 42 projecting from the bottom surface 41a, and the body portion 42 of the screw 40 acts as a stub.

This is how the propagation of the radiation current is suppressed at the position of the screw 40.

To make the screw 40 effectively suppress the propagation of the radiation current, it is desirable that an electrical length of the portion acting as the stub be a length corresponding to a wavelength of noise desired to be suppressed. In the following description, the portion acting as a stub is referred to as a stub portion. The stub portion is a projecting portion formed as part of a conductive member (the screw 40 in this example) for exhibiting an effect of suppressing propagation of radiation current, the projecting portion projecting with respect to a portion that would be in electrical contact with a propagation path of the radiation current if the conductive member is not provided, and is a substantially rod-shaped portion not electrically connected to any other conductive member. In the following description, a physical length of the stub portion is denoted by L, and the electrical length of the stub portion is denoted by Le. In the present embodiment, the entire body portion 42 of the screw 40 acts as the stub portion, and the length of the body portion 42, that is, the length from the bottom surface 41a of the head 41 to a tip portion 42b of the body portion 42, substantially coincides with the length L of the stub portion.

In a case where a wavelength corresponding to a frequency used by the antenna 20 in the wireless communication is denoted by λ, the electrical length Le of the stub portion of the screw 40 preferably is equal to or larger than one-eighth but equal to or smaller than three-eighths of λ, and more preferably is an approximate length of λ/4. When the stub portion is disposed in the air and nothing is in contact with the stub portion, the electrical length Le of the stub portion substantially coincides with the actual length L. When the stub portion has a surface in contact with a dielectric, by contrast, the electrical length Le of that surface portion becomes larger than the actual length, depending on a relative permittivity of the dielectric. Specifically, in a case where a portion having a length Lx in the stub portion is in contact with a dielectric having a relative permittivity ε, an electrical length Lex of that portion becomes √ε times the length Lx. Thus, as the portion in contact with the dielectric is larger, the physical length of the body portion 42 of the screw 40 necessary for suppressing radiation current of the same wavelength can be made smaller.

In the present embodiment, the screw 40 is fixed to a screw receiver 45 as illustrated in FIG. 2. The screw receiver 45 is formed from a dielectric and has a screw hole 45a used for engagement with the screw 40. The screw 40 is fastened to the screw receiver 45 with the board 10 interposed therebetween, so that the screw 40 is fixed to the board 10. The screw receiver 45 causes the electrical length Le of the body portion 42 of the screw 40 to be larger than the physical length L.

Moreover, the screw receiver 45 may be a member fixed to an enclosure of the electronic device 1a or the like.

With this configuration, the screw 40 plays not only a role of suppressing radiation current but also a role of fixing the board 10 incorporated in the electronic device 1a to the enclosure of the electronic device 1a. In other words, by making the length L of the stub portion of the screw 40 a length corresponding to a wavelength of electric waves used in the wireless communication, it is possible to additionally assign the screw 40 used in fixing of the board 10 the function of suppressing propagation of radiation current. Accordingly, radiation current can be suppressed without the need for attachment of other extra structures or the like.

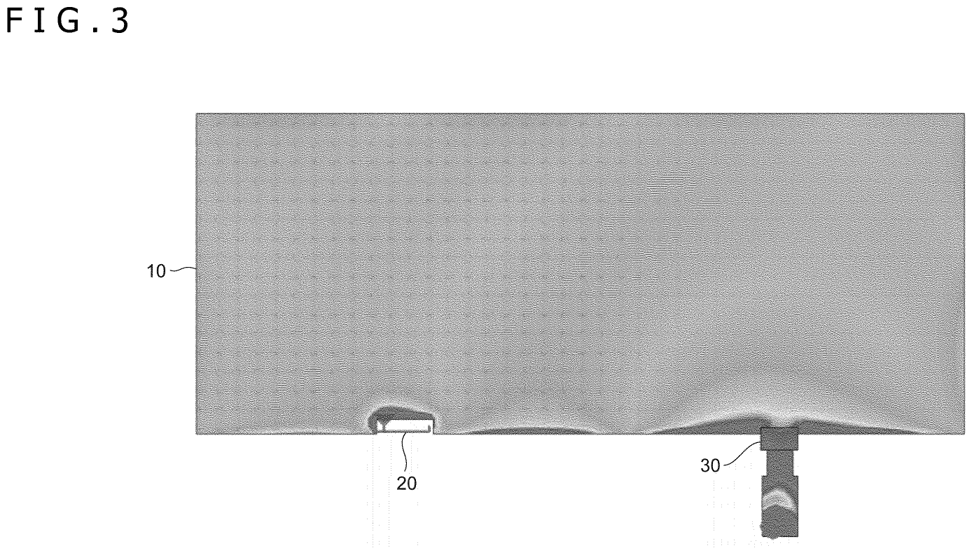

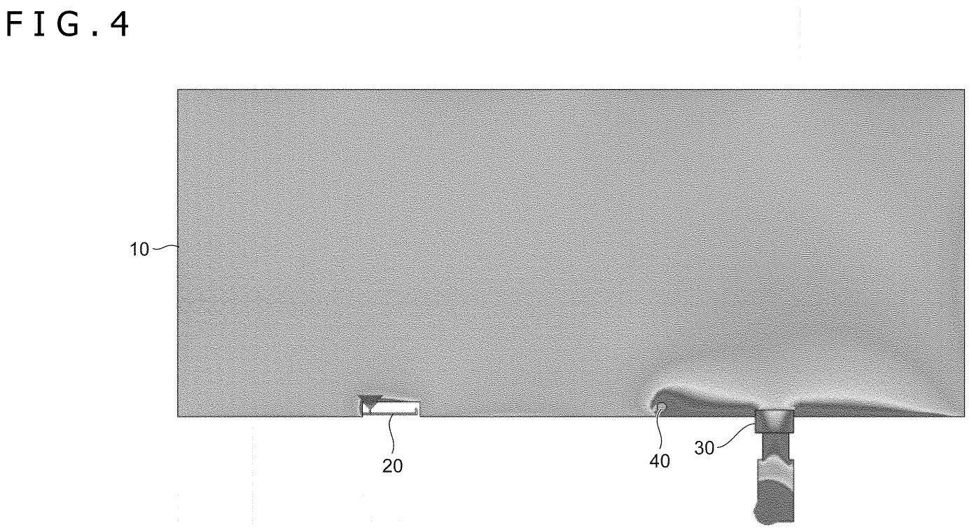

FIG. 3 and FIG. 4 illustrate simulation results of distribution of the radiation current generated from the connector 30 disposed on the board 10, each figure depicting the board 10 as viewed in plan. In these figures, portions with higher density indicate where stronger radiation current is generated. FIG. 3 illustrates distribution of the radiation current in a case where the screw 40 does not exist, whereas FIG. 4 illustrates distribution of the radiation current in a case where the screw 40 exists. In the case where the screw 40 does not exist, the radiation current generated from the connector 30 mainly is propagated through the propagation path along the side N where the connector 30 is disposed, as illustrated in FIG. 3. Meanwhile, in the case where the screw 40 exists, as can be seen in FIG. 4, although strong radiation current appears around the screw 40, the radiation current is not propagated beyond the screw 40, and there is almost no influence of the radiation current on the vicinity of the antenna 20 disposed on a side opposite to the connector 30 across the screw 40. Thus, with the screw 40 disposed, it is possible to suppress the influence of the radiation current generated from the connector 30 on the antenna 20.

As mentioned earlier, the screw 40 is disposed at a position along the side N between the connector 30 and the antenna 20, so that the propagation of the radiation current from the connector 30 to the antenna 20 can effectively be suppressed. Further, the screw 40 may be disposed at a position closer to the connector 30 (that is, a position at a shorter distance from the connector 30 than from the antenna 20). In this manner, the range affected by the radiation current can be limited to a narrower area.

As described above, with the electronic device 1a according to the present embodiment, the screw 40 can suppress the propagation of the radiation current generated on the board 10 due to the communication via the connector 30, and the influence of the radiation current on the antenna 20 can be suppressed.

### Second Embodiment

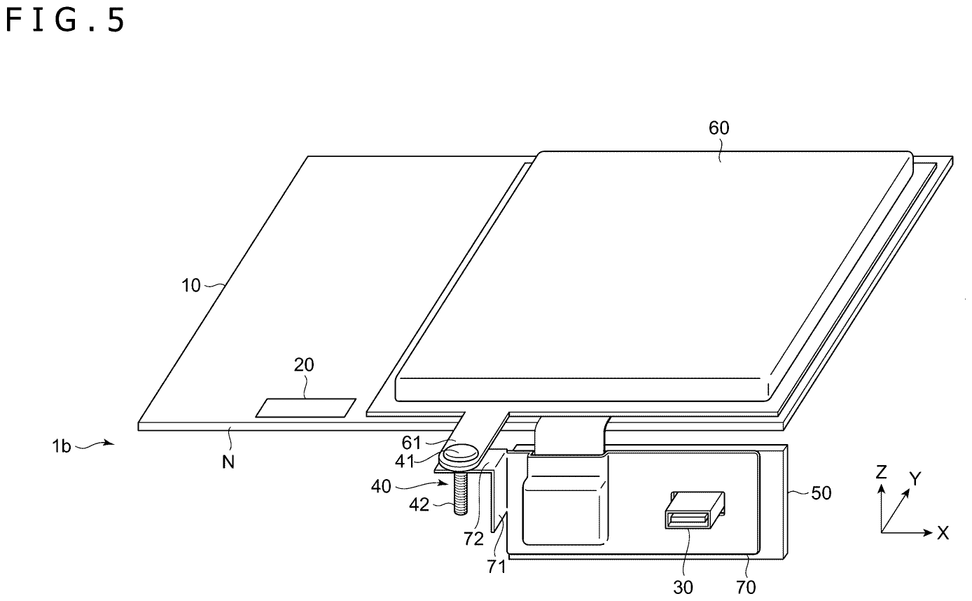

Next, an electronic device 1b according to a second embodiment of the present invention is described with reference to FIG. 5. It is to be noted that, in the following description, constituent elements that perform actions similar to those of corresponding constituent elements in the first embodiment are denoted by the same reference signs, and detailed description thereof is omitted.

In the present embodiment, the antenna 20 and the connector 30 do not exist on the same board, and they are disposed on boards different from each other. Specifically, the antenna 20 is disposed on the board 10 which is a main board of the electronic device 1b, and the connector 30 is disposed on a sub-board 50.

The board 10 has a rectangular shape in plan view and is disposed lying in parallel with the XY plane as in the first embodiment. Further, the antenna 20 is disposed along the side N extending in parallel with the X axis.

The sub-board 50 is disposed lying in parallel with an XZ plane at a position on the Y-axis negative direction side with respect to the side N of the board 10. That is, the sub-board 50 is disposed in such an orientation that the sub-board 50 is orthogonal to the board 10. The connector 30 is disposed on the sub-board 50 and oriented to the Y-axis negative direction.

Although the antenna 20 and the connector 30 are disposed on the separate boards in the present embodiment, a ground is shared by boards in a typical electronic device. That is, a ground for the board 10 and a ground for the sub-board 50 are electrically connected with each other. Hence, even though the antenna 20 and the connector 30 are mounted on the separate boards, the radiation current generated from the connector 30 may be propagated to the antenna 20, interfering with the wireless communication of the antenna 20. To cope with this problem, as in the first embodiment, a conductive member such as a screw acting as a stub is disposed in the middle of the propagation path of the radiation current from the connector 30 to the antenna 20.

Accordingly, the propagation of the radiation current can be suppressed.

Specifically, in the present embodiment, a shield 60 is fixed to the board 10, and a shield 70 is fixed to the sub-board 50.

The shield 60 is, for example, formed from a conductive material such as a metal plate having a flat plate shape and is fixed to the board 10 in such a manner as to cover at least part of the front surface of the board 10. It is to be noted here that the shield 60 is disposed not to cover the antenna 20 but to cover other areas of the board 10. The shield 60 is in contact with the ground pattern of the board 10 and hence is electrically connected to the ground of the board 10.

Moreover, in the present embodiment, the shield 60 is formed with a blade portion 61. The blade portion 61 has a plate shape lying in parallel with the front surface of the board 10 and is disposed at such a position that the blade portion 61 projects from a main body of the shield 60 to the Y-axis negative direction side and does not overlap the board 10.

The shield 70 is also formed from a conductive material such as a metal plate as with the shield 60 and is fixed to the sub-board 50 in such a manner as to cover at least part of a front surface of the sub-board 50. Further, the shield 70 is in contact with a ground pattern of the sub-board 50 and hence is electrically connected to the ground of the sub-board 50.

Moreover, in the present embodiment, the shield 70 is formed with a blade portion 71. The blade portion 71 has a plate shape lying perpendicularly to the front surface of the sub-board 50. The blade portion 71 is formed in a manner being bent at an end portion of a main body of the shield 70 on the X-axis negative direction side and extending to the Y-axis negative direction side. To the blade portion 71, there is further coupled a bent portion 72 extending in a direction orthogonal to the blade portion 71. Specifically, the bent portion 72 is a portion that is coupled to an end portion of the blade portion 71 on the Z-axis positive direction side and extends to the Y-axis negative direction side, and is disposed lying in parallel with the front surface of the board 10. Further, in the state in which the shield 60 and the shield 70 are fixed to the board 10 and the sub-board 50, respectively, the bent portion 72 overlaps and makes contact with a tip portion of the blade portion 61 of the shield 60.

In addition, a through hole is defined in each of the bent portion 72 and the tip portion of the blade portion 61 at such positions that the through holes overlap each other. In the present embodiment, the screw 40 having the stub portion is fitted into these through holes and fixed. It is to be noted that, as in the first embodiment, the screw 40 may be fastened to a screw receiver (not illustrated) that is fixed to an enclosure of the electronic device 1b or the like. Thus, the shield 60 and the shield 70 are fastened together by the screw 40, and the screw 40 is electrically connected to both the shield 60 and the shield 70.

With such a configuration, provided that there is no action by the screw 40, the radiation current generated from the connector 30 is considered to be mainly propagated through a propagation path from the ground of the sub-board 50 to the shield 70, from the bent portion 72 of the shield 70 to the blade portion 61 of the shield 60, and further from the shield 60 to the ground of the board 10 and affect the antenna 20. By disposing the screw 40 acting as a stub in the middle of the propagation path of the radiation current, it is possible to suppress the influence of the radiation current on the antenna 20.

Specifically, as in the first embodiment, the bottom surface of the head 41 of the screw 40 makes contact with the blade portion 61, so that the body portion 42 of the screw 40 acts as a stub portion. By setting the electrical length Le of the stub portion to have a value equal to or larger than (⅛)) but equal to or smaller than (⅜)) () is the wavelength corresponding to the frequency used by the antenna 20 in the wireless communication), it is possible to prevent components of the wavelength A of the radiation current from being propagated to an area beyond the screw 40.

In the present embodiment, the screw 40 is fixed to the shield 60 and the shield 70. With this, even in a case where it is difficult to fix the screw 40 directly to the board 10 or the sub-board 50 due to a problem in terms of layout, it is possible to obtain an effect of suppressing the propagation of the radiation current.

Further, in a case where the screw 40 is fastened to a screw receiver formed from a dielectric as described above, the electrical length Le of the body portion 42 of the screw 40 becomes larger than the physical length L due to contact with a screw hole provided in this screw receiver formed from the dielectric. Hence, propagation of radiation current of a target wavelength can be suppressed by a relatively small length L. Moreover, the screw 40 is fastened to the screw receiver to fasten the shield 60 and the shield 70 together, and this means that the screw 40 fixes both the shield 60 and the shield 70. When this screw receiver is fixed to the enclosure of the electronic device 1b, the screw 40 also plays a role of fixing an entire unit including the board 10, the sub-board 50, the shield 60, and the shield 70 to the enclosure of the electronic device 1b. Thus, as in the first embodiment, it is possible to additionally assign the screw 40 used in fixing of the respective boards and shields to the enclosure of the electronic device 1b the function of suppressing the propagation of radiation current. Accordingly, the radiation current can be suppressed without the need for attachment of other extra structures or the like.

### Modification Examples

Embodiments of the present invention are not limited to those described above and may be modified in various manners.

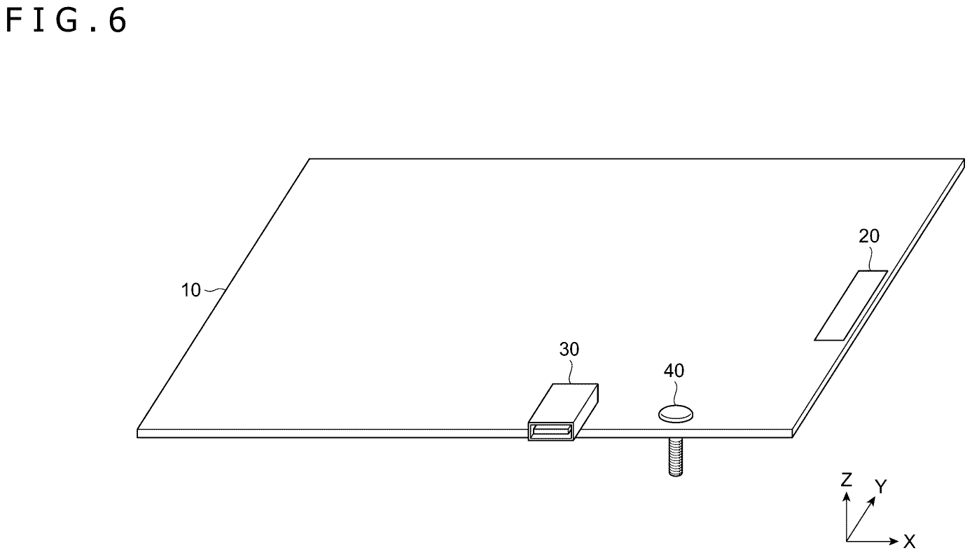

For example, the antenna 20 and the connector 30 may be disposed along different sides on the same board 10. FIG. 6 illustrates an example of such an embodiment. In the example of this figure, the connector 30 is disposed along the side located on the Y-axis negative direction side, and the antenna 20 is disposed along a side that is located on the X-axis positive direction side and that is different from the side located on the Y-axis negative direction side. In this case as well, since the radiation current generated from the connector 30 is propagated along the outer boundary of the board 10, disposing the screw 40 in the middle of this propagation path enables suppression of the propagation of the radiation current.

Further, also in the case where the antenna 20 and the connector 30 are disposed on different boards as in the second embodiment, the screw 40 may be fixed on either one of the boards or may be fixed at another position on the shield 60 or the shield 70. Moreover, the orientation of the screw 40 may also be modified from the one described above, and, for example, the screw 40 may be disposed in a reversed orientation. In any case, by fixing the screw 40 acting as a stub in the middle of the propagation path through which the radiation current is propagated from the connector 30 to the antenna 20, it is possible to suppress the propagation of the radiation current.

In addition, while the screw 40 is in direct contact with the ground of the board 10 or with the shield 60 on the propagation path of the radiation current in the above description, this is not the sole example. The screw 40 may be electrically connected to the propagation path of the radiation current by capacitive coupling.

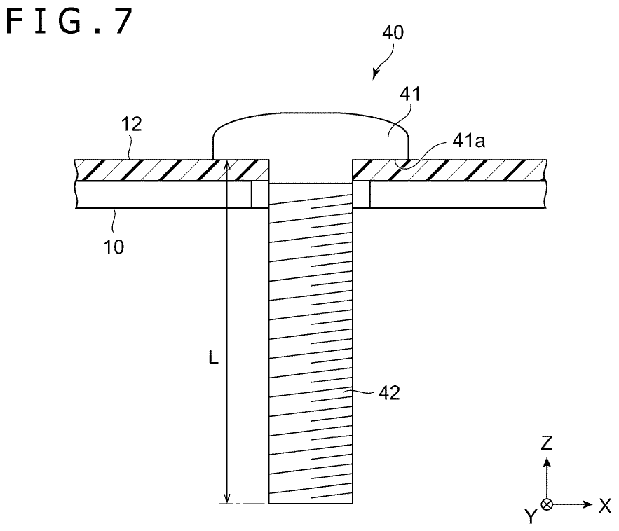

FIG. 7 is a diagram illustrating an example of such an embodiment. As with FIG. 2, FIG. 7 illustrates the screw 40 as viewed in the horizontal direction. In the example of this figure, a dielectric layer 12 is formed on the front surface of the board 10, and the screw 40 is not in direct contact with the ground of the board 10. However, the ground pattern of the front surface of the board 10 is capacitively coupled to the bottom surface 41a of the head 41 of the screw 40 with the dielectric layer 12 interposed therebetween. In this case as well, as in the first embodiment, the body portion 42 projecting from the bottom surface 41a of the head 41 of the screw 40 acts as a stub portion. Thus, it is possible to suppress the propagation of the radiation current of the wavelength corresponding to the electrical length Le of the body portion 42 of the screw 40. It is to be noted that, although illustration is omitted in FIG. 7, the screw 40 may be fixed to a screw receiver formed from a dielectric as in FIG. 2.

In the description so far, the body portion 42 of the screw 40 acts as a stub portion in any of the embodiments. However, embodiments of the present invention are not limited to such cases, and any conductive member can be used in place of the screw 40 as long as the conductive member is electrically connected to the propagation path of radiation current and has a stub portion projecting from the propagation path.

For example, in a case where the screw 40 is fixed to a screw receiver formed not from a dielectric but from a conductor, the screw 40 alone does not act as a stub. However, since the body portion 42 of the screw 40 makes contact with the screw receiver formed from the conductor, propagation of radiation current can be suppressed when the whole unit also including the screw receiver formed from the conductor acts as a stub portion.

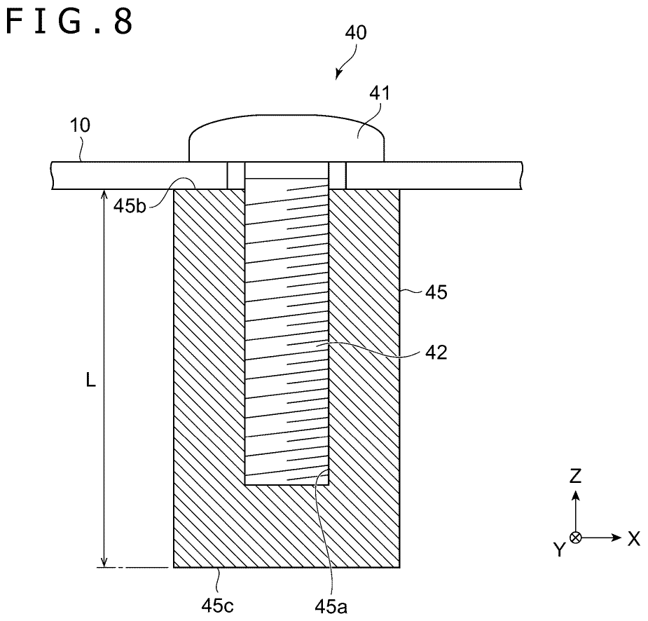

FIG. 8 is a diagram illustrating an example of such an embodiment. In the example of this figure, although the screw 40 is fastened to the screw hole 45a defined in the screw receiver 45 as in FIG. 2, the screw receiver 45 has a substantial rod shape and, unlike the first embodiment, is formed from a conductive material. It is to be noted that, in the example of this figure, an upper surface 45b of the screw receiver 45 is in contact with the back surface of the board 10. Hence, it is a front surface portion of the screw receiver 45 that projects from the ground of the board 10 included in the propagation path of radiation current and acts as a stub portion. That is, a longitudinal length of the screw receiver 45 (length from the upper surface 45b to a bottom surface 45c) becomes the length L of the stub portion.

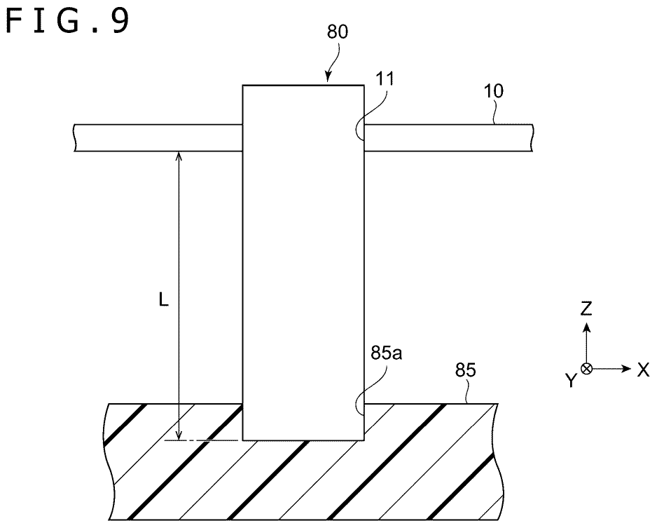

The conductive member having a portion acting as a stub portion may be a positioning boss. FIG. 9 is a diagram illustrating an example of such an embodiment. In the example of this figure, a boss 80 is inserted through the through hole 11 defined in the board 10, and a tip end of the boss 80 is inserted into a hole 85a defined in a boss receiver 85 formed from a dielectric. The board 10 is thus positioned relative to the boss receiver 85. It is to be noted that, as with the screw receiver 45 in FIG. 2, the boss receiver 85 is a member fixed to the enclosure of the electronic device.

In this example, the boss 80 has a side surface in contact with the through hole 11 defined in the board 10, so that the boss 80 is electrically connected to the ground of the board 10. Thus, that portion of the boss 80 projecting from the back surface side of the board 10 acts as a stub portion. The length L of the stub portion in this case is equal to the length of that portion of the boss 80 ranging from the back surface of the board 10 to the tip portion as illustrated in the figure.

As described above, the conductive member having a portion acting as a stub portion may be a member that as a whole has any of various shapes and sizes, but it is preferable that the portion acting as the stub portion be in a substantial rod shape, and it is preferable that the conductive member have such a shape that the longitudinal length L of the portion acting as the stub portion (length to the tip of the portion projecting from the propagation path of radiation current) is larger than the length thereof in another direction.

It is to be noted that, while only one conductive member having a stub portion is disposed between the antenna 20 and the connector 30 in the description above, a plurality of such conductive members may be disposed. In this case, by making the electrical lengths of stub portions in the respective conductive members different from one another, it is possible to suppress radiation current of a plurality of wavelengths. For example, in a case where the antenna 20 performs wireless communication at two wavelengths, i.e., λ1 and λ2, noise reduction can be achieved in both wavelengths by disposing two conductive members, i.e., a conductive member having a stub portion with the electrical length Le corresponding to the wavelength λ1 and a conductive member having a stub portion with the electrical length Le corresponding to the wavelength λ2, between the antenna 20 and the connector 30.

Moreover, while the connector 30 that performs communication at a relatively high speed acts as a noise source causing generation of radiation current in the description above, this is not limitative. Any of various circuit elements that causes generation of radiation current to be propagated through a ground of a circuit in an electronic device may be a noise source. In addition, while the antenna 20 is a pattern antenna formed on the board 10 in the description above, this is not limitative. The antenna 20 may be any of various antennas connected to the board 10.

### REFERENCE SIGNS LIST

1a, 1b: Electronic device
10: Board
20: Antenna
30: Connector
40: Screw
45: Screw receiver
50: Sub-board
60, 70: Shield
80: Boss
85: Boss receiver

1. An electronic device comprising:
an antenna for performing wireless communication;
a noise source that causes generation of radiation current; and
a conductive member that is disposed on a propagation path of the radiation current from the noise source to the antenna and has a projecting portion projecting from the propagation path, wherein an electrical length to a tip end of the projecting portion is equal to or larger than one-eighth but equal to or smaller than three-eighths of a wavelength used in the wireless communication.

2. The electronic device according to claim 1, further comprising:
a board to which the antenna is connected, wherein the conductive member is a screw fixed to the board.

3. The electronic device according to claim 1, further comprising:
a board to which the antenna is connected;

4.-6. (canceled)

7. The electronic device according to claim 3, further comprising:
a shield covering at least part of the board, wherein the conductive member is a screw fixed to the shield.

8. The electronic device according to claim 7, further comprising:
a second board different from the board to which the antenna is connected, the noise source being connected to the second board.

9. The electronic device according to claim 8, further comprising:
a second shield covering at least part of the second board, wherein the second shield has a portion overlapping the shield.

10. The electronic device according to claim 9, where the shield and the second shield are fastened together at the portion overlapping the shield by the screw.

11. The electronic device according to claim 2, wherein the screw is fixed to a screw clamp formed from a dielectric.

12. The electronic device according to claim 1, further comprising:
a board to which the antenna is connected, wherein a screw is fixed to the board.

13. The electronic device according to claim 12, wherein the conductive member is a screw receiver to which the screw is fixed.

14. The electronic device according to claim 1, further comprising:
a board to which the antenna is connected, wherein the antenna is a pattern antenna formed on the board.

15. The electronic device according to claim 14, wherein the antenna is disposed near one side among four sides comprising an outer boundary of the board.

16. The electronic device according to claim 1, comprising:
a connector, wherein the connector is a circuit element providing a wired communication connection with another electronic device.

17. The electronic device according to claim 16, wherein the connector is a universal serial bus (USB) or a high-definition multimedia interface (HDMI).

18. The electronic device according to claim 16, wherein, when another electronic device is connected to the connector, a radiation current is generated on a ground pattern formed on a front surface of a board to which the connector is mounted.

19. The electronic device according to claim 18, wherein the radiation current is propagated through the ground pattern.

20. The electronic device according to claim 18, wherein the radiation current is propagated on the board along an outer boundary of the board.

21. The electronic device according to claim 12, comprising:
a connector, wherein the connector is a circuit element providing a wired communication connection with another electronic device, and wherein the screw is disposed between the antenna and the connector.

22. The electronic device according to claim 18, wherein a bottom surface of a head of a screw makes contact with the ground pattern and is electrically connected to a propagation path of the radiation current.

23. The electronic device according to claim 22, wherein a body portion of the screw acts as a stub, and wherein an electrical length of the body portion of the screw corresponds to a wavelength of noise for suppression.
